(19) United States
(12) Patent Application Publication
(10) Pub. No.: US 2023/0339483 A1
(43) Pub. Date: Oct. 26, 2023

(54) REDUNDANT SENSING SYSTEMS IN DRIVE-BY-WIRE SYSTEMS

(71) Applicant: KSR IP Holdings, LLC, Wilmington, DE (US)

(72) Inventors: Rachel Luu, Chatham (CA); Jaesung Kim, Ridgetown (CA); Lingmin Shao, London (CA)

(21) Appl. No.: 18/137,810

(22) Filed: Apr. 21, 2023

Related U.S. Application Data
(60) Provisional application No. 63/333,685, filed on Apr. 22, 2022.

(51) Int. Cl. B60W 50/023

(52) U.S. Cl. CPC B60W 50/023; B60W 2420/503

(57) ABSTRACT

Embodiments herein are directed to a redundant sensing system that includes a first sensor, a second sensor, and an electronic control unit. The first sensor is configured to output a first data indicative of a position data and the second sensor is configured to output a second data indicative of the position data. The electronic control unit is configured to determine whether the first data is within a first predetermined threshold range. When the first data is outside of the first predetermined threshold range, determine whether the second data is within a second predetermined threshold range. The electronic control unit is configured to control the redundant sensing system to operate with the second sensor when the first data is outside of the first predetermined threshold range and the second data is within the second predetermined threshold range.

### CROSS-REFERENCE TO RELATED APPLICATIONS

This utility patent application claims priority benefit from U.S. Provisional Patent Application Ser. No. 63/333,685 filed Apr. 22, 2022, and entitled “Redundant Electrical Control Units Having Buffer Arrays in Drive-By-Wire Systems”, the entire contents of which is incorporated herein in its entirety.

### TECHNICAL FIELD

The present specification generally relates redundant electronic control units, and, more specifically, to redundant electronic control units using a plurality of buffer arrays for meeting fail-operational applications.

### BACKGROUND

It is known in automotive systems, such as brake-by-wire and steering-by-wire systems, that redundant electronic control units are desirable in case one of the electronic control units fail. However, in these applications, there are multiple sensors and therefore multiple electronic control units and backup electronic control units are required to receive signals from each of the sensors of the system. Such arrangements are expensive. Further, these arrangements include more sensor data that must be interpreted by electronic control units, which in turn raises the risk for more errors. For example, errors in calculations are more likely to occur. Additionally, each of the electronic control units cannot be arranged in a parallel configuration because if one of the electronic control units fail and short out, the rest of the electronic control units are affected.

As such, a need exists to limit the number of the electronic control units while also including a redundant electronic control unit system.

### SUMMARY

In one embodiment, a redundant sensing system is provided. The redundant sensing system includes a first sensor, a second sensor, and an electronic control unit. The first sensor is configured to output a first data indicative of a position data. The second sensor is configured to output a second data indicative of the position data. The electronic control unit is communicatively coupled to the sensor and the second sensor. The electronic control unit is configured to receive the first data indicative of the position data and the second data indicative of the position data. The electronic control unit is further configured to determine whether the first data indicative of the position data is within a first predetermined threshold range, the first predetermined threshold range being a range of normal operation of the first sensor and the electronic control unit, when the first data is outside of the first predetermined threshold range, determine whether the second data indicative of the position data is within a second predetermined threshold range, the second predetermined threshold range being a range of normal operation of the second sensor and the electronic control unit, and control the redundant sensing system to operate with the second sensor when the first data is outside of the first predetermined threshold range and the second data is within the second predetermined threshold range.

In another embodiment, a redundant sensing system is provided. The redundant sensing system includes a first sensor, a second sensor, a third sensor, a first electronic control unit, a second electronic control unit and a third electronic control unit. The first sensor is configured to output a first data indicative of a position data. The second sensor is configured to output a second data indicative of the position data. The third sensor is configured to output a third data indicative of the position data. The first electronic control unit is communicatively coupled to the first sensor, the second sensor and the third sensor and is configured to receive the first data indicative of the position data, the second data indicative of the position data, and the third data indicative of the position data. The second electronic control unit is communicatively coupled to the first sensor, the second sensor and the third sensor and is configured to receive the first data indicative of the position data, the second data indicative of the position data, and the third data indicative of the position data. The third electronic control unit is communicatively coupled to the first sensor, the second sensor and the third sensor and is configured to receive the first data indicative of the position data, the second data indicative of the position data, and the third data indicative of the position data. The first electronic control unit is further configured to determine whether the first data indicative of the position data is within a first predetermined threshold range, the first predetermined threshold range being a range of normal operation of the first sensor and the first electronic control unit, when the first data is outside of the first predetermined threshold range, determine whether the second data indicative of the position data is within a second predetermined threshold range, the second predetermined threshold range being a range of normal operation of the second sensor and the first electronic control unit, and control the redundant sensing system to operate with the second sensor when the first data is outside of the first predetermined threshold range and the second data is within the second predetermined threshold range.

In yet another embodiment, a redundant sensing system is provided. The redundant sensing system includes a first integrated circuit, a second integrated circuit, and an electronic control unit. The first integrated circuit has a first measurement sensor configured to output a first data indicative of a position data. The second integrated circuit has a second measurement sensor configured to output a second data indicative of the sensed position. The electronic control unit is communicatively coupled to the first integrated circuit and the second integrated circuit. The electronic control unit is configured to receive the first data indicative of the sensed position and the second data indicative of the sensed position. The electronic control unit is further configured to determine whether the first data indicative of the sensed position is within a first predetermined threshold range, the first predetermined threshold range being a range of normal operation of the first integrated circuit and the electronic control unit, when the first data is outside of the first predetermined threshold range, determine whether the second data indicative of the sensed position is within a second predetermined threshold range, the second predetermined threshold range being a range of normal operation of the second integrated circuit and the electronic control unit, and control the redundant sensing system to operate with the second integrated circuit when the first data is outside of the first predetermined threshold range and the second data is within the second predetermined threshold range.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, wherein like structure is indicated with like reference numerals and in which:

FIG. 1 schematically depicts an example hanging pedal assembly that includes a redundant sensing system, according to one or more embodiments described and illustrated herein;

FIG. 2 schematically depicts an example floor mounted pedal assembly that includes the redundant sensing system of FIG. 1, according to one or more embodiments described and illustrated herein;

FIG. 3 schematically depicts an example steer-by-wire assembly that includes the redundant sensing system of FIG. 1, according to one or more embodiments shown and described herein;

FIG. 4 schematically depicts an isolated view of a first aspect of the redundant sensing system of FIG. 1, according to one or more embodiments shown and described herein;

FIG. 5 schematically depicts an isolated view of a second aspect of the redundant sensing system of FIG. 1, according to one or more embodiments shown and described herein; and

FIG. 6 schematically depicts a flow diagram of an illustrative method for determining whether a failure of the redundant sensing system of FIG. 1 has occurred, according to one or more embodiments shown and described herein.

### DETAILED DESCRIPTION

Embodiments herein are directed to a redundant sensing system that includes redundant electronic control units (ECU) and redundant sensors. The redundant sensing system may be a board-level implantation and/or a chip-level implementation. As such, the redundant sensing system may be configured to determine whether a data indicative of a sensed position is within a first predetermined threshold range in which the first predetermined threshold range is a range of normal operation of the sensor and one of the electronic control units. When the data is outside of the first predetermined threshold range, the electronic control unit may determine whether a second data indicative of the sensed position is within a second predetermined threshold range in which the second predetermined threshold range is a range of normal operation of the second sensor and the electronic control unit. The electronic control unit may control the redundant sensing system to operate with the second sensor when the data is outside of the first predetermined threshold range and the second data is within the second predetermined threshold range. Further, the electronic control unit may be configured to compare the data received from the first sensor by one electronic control unit with the same data received from the first sensor by another electronic control unit to determine whether a variation exists indicative of an abnormal operation of the first sensor, the second sensor, or the electronic control unit.

As such, the redundant sensing system may utilized in any sensing application where there is a need to minimize the number of sensors, electronic control units, and the amount of data that must be calculated or determined from the sensed information. Further, as discussed herein, the redundant sensing system disclosed herein provides advantages over conventional systems by minimizing the number of sensors, minimizing the number of electronic control units, communication between the electronic control units when deviations are determined to troubleshoot the root cause of the deviation, and automatic switching and/or assignment of sensors or electronic control units to use in the system.

Example sensing applications include, without limitation, brake-by-wire systems, steering-by-wire systems, torque applications, and/or the like, where it is desirable to include redundant electronic control units and where sensors are positioned to obtain and transmit similar data to the respective electronic control units. It should be appreciated that the sensing system is not limited to automotive applications and may be in all-terrain vehicles (ATV), off-road vehicles (ORV), aerospace, marine and/or in other applications.

Various embodiments of the redundant sensing system are described in detail herein.

As used herein, the term “communicatively coupled” means that coupled components are capable of exchanging data signals and/or electric signals with one another such as, for example, electrical signals via conductive medium, electromagnetic signals via air, optical signals via optical waveguides electrical energy via conductive medium or a non-conductive medium, data signals wirelessly and/or via conductive medium or a non-conductive medium and the like.

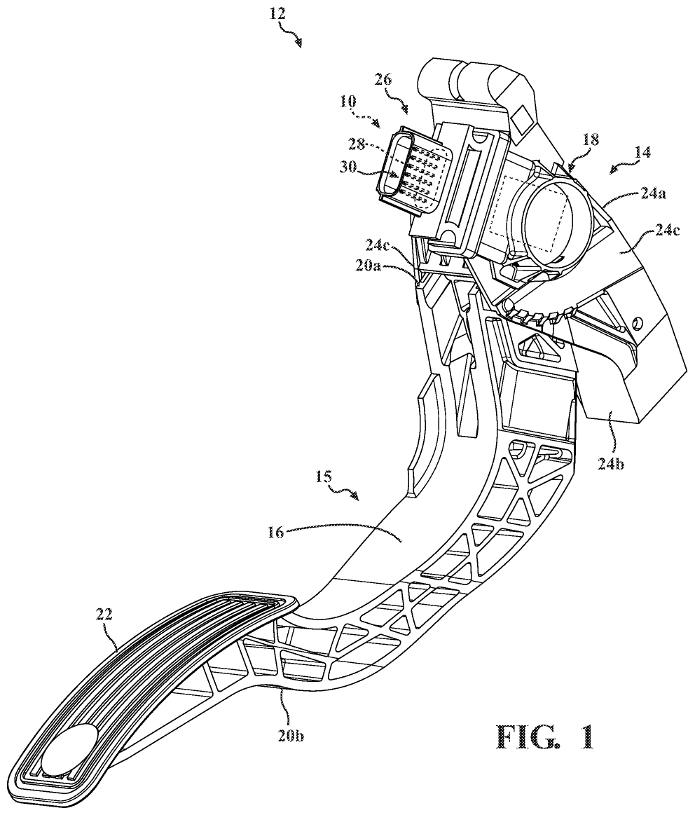

Referring initially to FIG. 1, in one non-limiting example, a redundant sensing system 10 may be positioned to sense a movement of an example hanging pedal assembly 12 as schematically depicted. It should be understood that while the example hanging pedal assembly 12 is depicted as an electronic throttle control (ETC) pedal assembly, this is non-limiting and the example hanging pedal assembly 12 may be a hanging brake pedal, a hanging clutch pedal, and/or any other hanging pedal assembly where sensing a movement thereof is desirable. As such, for example purposes, the example hanging pedal assembly 12 will only be briefly described.

The example hanging pedal assembly 12 includes a housing 14 and a pedal arm assembly 15. The pedal arm assembly 15 includes a pedal arm 16, which includes a hub portion 18. The hub portion 18 is pivotally mounted to the housing 14. The pedal arm 16 includes a proximate end 20a and an opposite distal end 20b. A pedal pad 22 is positioned at a distal end 20b. As such, the pedal arm 16 pivots, moves, and/or rotates within the housing 14 based on a pressure applied to the pedal pad 22 at the distal end 20b of the pedal arm 16.

The housing 14 may include a back wall 24a and an opposite front wall 24b and a pair of sidewalls 24c to enclose positions of the hub portion 18. In this example, the redundant sensing system 10 may be incorporated into a connector assembly 26 that extends from the housing 14. That is, the redundant sensing system 10 may positioned to sense any movement of the hub portion 18 caused by pressure applied to the pedal pad 22. The connector assembly 26 may include a plurality of terminals 28 provided in a connector cavity 30, to communicatively and/or electrically connect the redundant sensing system 10 to other components of a vehicle such as an electronic control module and/or a powertrain controller. In some embodiments, the connector assembly 26 may be overmolded.

As such, in the example hanging pedal assembly 12, the redundant sensing system 10 is configured to sense the amount of movement of the pedal arm 16 at the hub portion 18 within the housing 14 based on the pressure applied to the pedal pad 22 at the distal end 20b of the pedal arm 16, as discussed in greater detail herein.

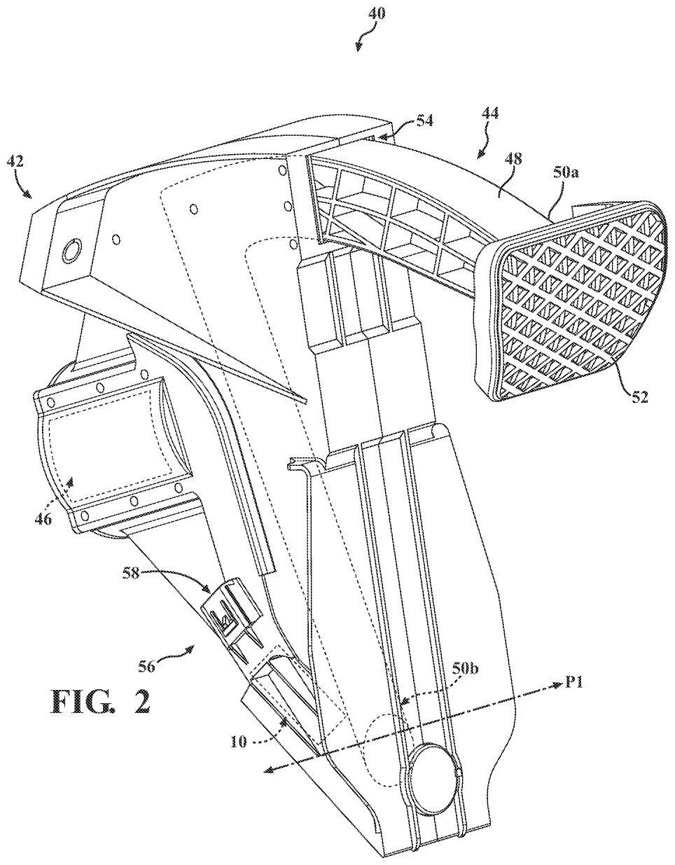

Referring now to FIG. 2, in another non-limiting example, the redundant sensing system 10 may be positioned to sense a movement of an example floor mounted pedal assembly 40 as schematically depicted. It should be understood that while the floor mounted pedal assembly 40 is depicted as a brake pedal emulator pedal assembly, this is non-limiting and the floor mounted pedal assembly 40 may be an accelerator pedal, such as an electronic throttle control pedal, a floor mounted brake pedal, a floor mounted clutch pedal, and/or any other floor mounted pedal assembly where sensing a movement thereof is desirable. As such, for example purposes, the floor mounted pedal assembly 40 will only be briefly described.

The floor mounted pedal assembly 40 includes a housing 42, a pedal arm assembly 44, and an emulator assembly 46. The pedal arm assembly 44 includes a pedal arm 48, which includes a pedal pad end 50a and a pivot end 50b. In some embodiments, such as the embodiment depicted, the pedal arm 48 may generally be L shaped. In other embodiments, the pedal arm 48 may be differently shaped such as a J or a T. The pivot end 50b is pivotally coupled to the housing 42 about a pivot axis P1. The pedal pad end 50a receives a pedal pad 52 that a foot of a user would depress against to brake, accelerate, and/or activate a clutch control. The housing 42 includes an opening 54 that receives portions of the pedal arm 48.

In this example, the redundant sensing system 10 may be incorporated into a connector assembly 56 that extends from the housing 42. That is, the redundant sensing system 10 may positioned to sense any movement of the pedal arm 48 at the pivot end 50b about the pivot axis P1 caused by pressure applied/released to the pedal pad 52. The connector assembly 56 may include a plurality of terminals provided in a connector cavity 58, to communicatively and/or electrically connect the redundant sensing system 10 to other components of a vehicle such as an electronic control module and/or a powertrain controller. In some embodiments, the connector assembly 56 may be overmolded.

As such, in the example floor mounted pedal assembly 40, the redundant sensing system 10 is configured to sense the amount of movement of the pedal arm 48 at the pivot end 50b about the pivot axis P1 caused by pressure applied/released to the pedal pad 52, as discussed in greater detail herein.

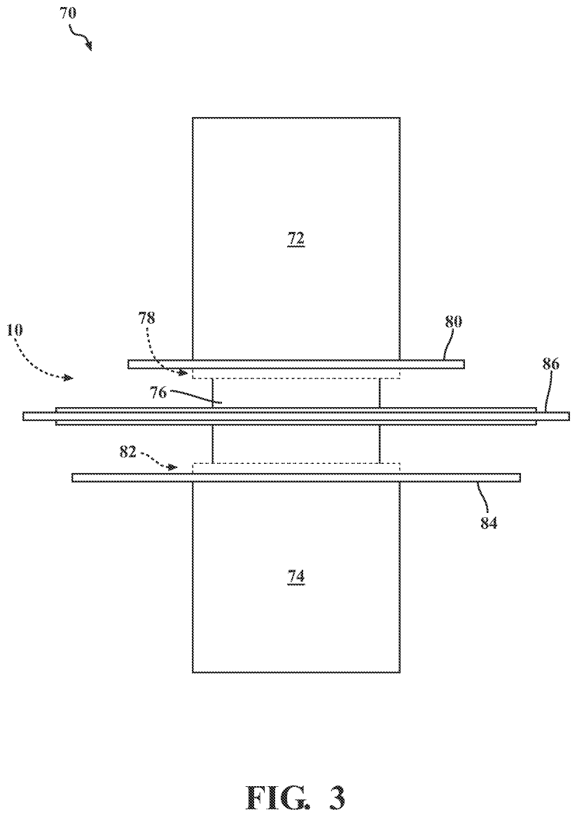

Referring now to FIG. 3, in yet another non-limiting example, the redundant sensing system 10 may be positioned to sense a movement of a steer-by-wire system 70 such as a steering wheel assembly. The steer-by-wire system 70 may include an input shaft 72 which may be coupled or otherwise attached to a steering wheel for the vehicle. An output shaft 74 may be coaxial with the input shaft 72. The output shaft 74 may be connected to the steering linkage for the vehicle to provide the actual pivoting of the vehicle wheels.

The input shaft 72 and the output shaft 74 may be coupled or otherwise connected together by a torsion bar. This torsion bar 76 may permit a limited amount of angular deflection between the input shaft 72 and the output shaft 74 depending upon the torque applied to the steering wheel. In the depicted embodiment, the redundant sensing system 10 may be include a first set of sensors 78 positioned at or attached to the input shaft 72 adjacent the torsion bar 76 so that a coupler 80 and input shaft 72 rotate in unison with each other. Similarly, a second set of sensors 82 positioned at or attached to the output shaft 74 adjacent the torsion bar 76 and a second conductive or coupler 84 may be attached to the output shaft 74 so that the second coupler 84 rotates in unison with the output shaft 74.

A circuit board 86, which may be attached to the vehicle frame or other structure, may be positioned in between the two couplers 80, 84 such that the circuit board 86 is generally parallel to the two couplers 80, 84. The circuit board 86 may be a printed circuit board, a flexible circuit board, and the like, and is configured to house components of the redundant sensing system 10, as discussed in greater detail herein.

In this example, the redundant sensing system 10 may be configured to sense an angular deflection between the two couplers 80, 84, which may be directly related to the torsion applied to the steering wheel. As such, the first set of sensors 78 and the second set of sensors 82 may be configured to sense and transmit to the components of the circuit board 86 the movement, deflection, rotation, and the like of the two couplers 80, 84 indicative of the movement of the input shaft 72 and the output shaft 74, respectively.

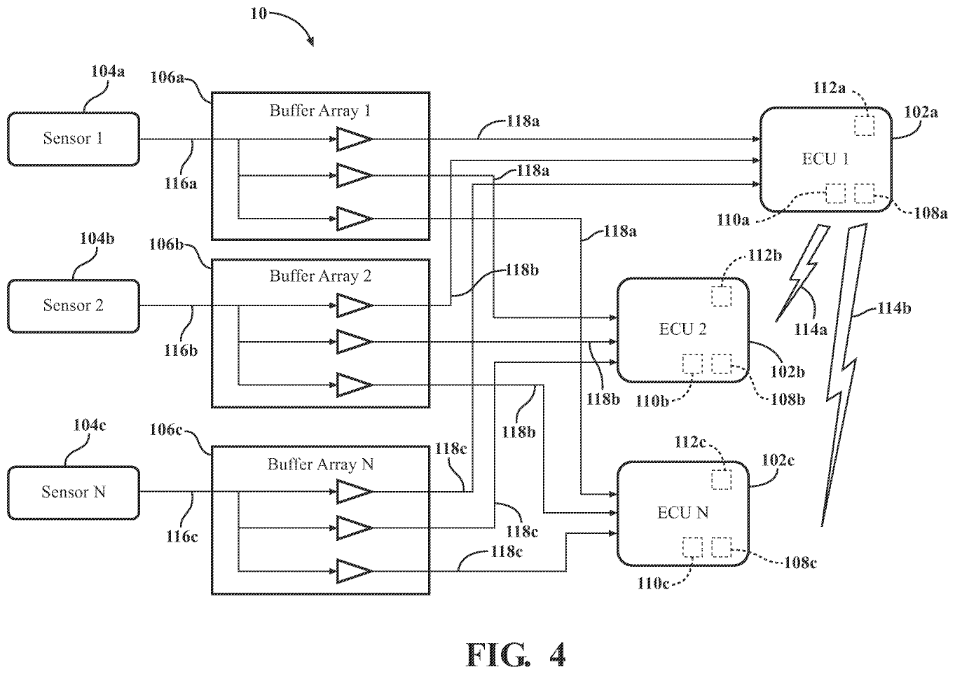

Now referring to FIG. 4, the redundant sensing system 10 includes electronic control units 102a, 102b, and is illustrated with a third “N” electronic control unit 102c. It should be understood that the third “N” electronic control unit 102c is optional and may be any number of additional ECUs used in the redundant sensing system 10 (i.e., one or more third electronic control units 102c). Each of the electronic control units 102a, 102b, 102c include a processor 108a, 108b, 108c, respectively, a memory unit 110a, 110b, 110c, respectively, and a data storage device 112a, 112b, 112c, respectively.

The processor 108a, 108b, 108c, such as a computer processing unit (CPU), may be the central processing unit of the each of the electronic control units 102a, 102b, 102c, to perform calculations, comparing values and received data such as the position data, and logic operations to execute a program, as discussed in greater detail herein. The processor 108a, 108b, 108c, alone or in conjunction with the other components, is an illustrative processing device, computing device, or combination thereof. The processor 108a, 108b, 108c, may include any processing component configured to receive and execute instructions (such as from the data storage device 112a, 112b, 112c, and/or the memory unit 110a, 110b, 110c, respectively).

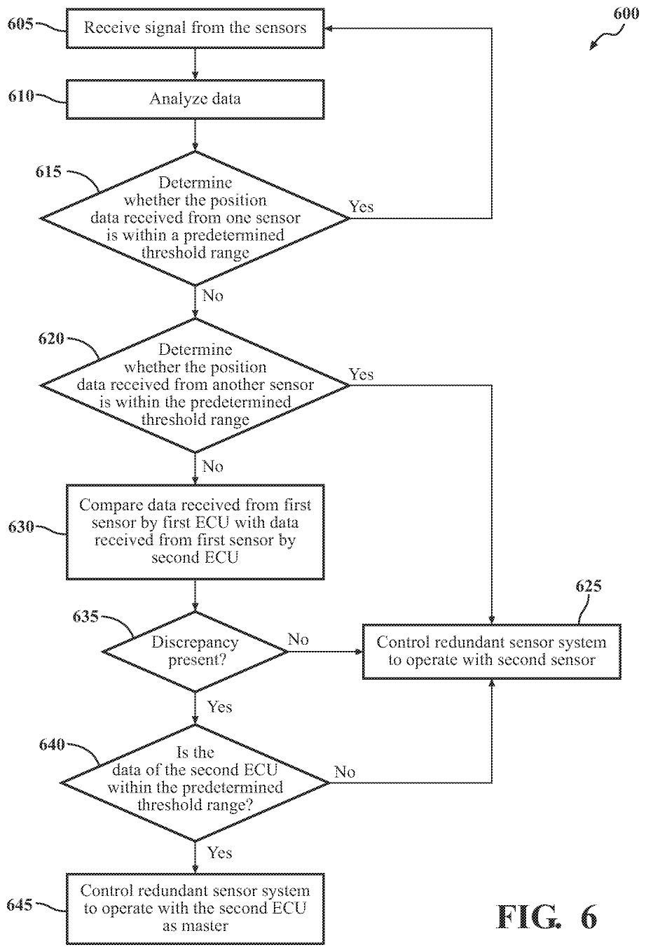

Each of the memory units 110a, 110b, 110c, may be configured as a volatile and/or a nonvolatile computer-readable medium and, as such, may include random access memory (including SRAM, DRAM, and/or other types of random access memory), read only memory (ROM), flash memory, registers, compact discs (CD), digital versatile discs (DVD), and/or other types of storage components. Each of the memory units 110a, 110b, 110c, may include one or more programming instructions thereon that, when executed by the processor 108a, 108b, 108c, cause the processor 108a, 108b, 108c, respectively, to complete various processes, such as the processes described herein with respect to FIG. 6. As such, each of the memory units 110a, 110b, 110c, may include the programming instructions that are embodied as a plurality of software logic modules, where each logic module provides programming instructions for completing one or more tasks, as described in greater detail below with respect to FIG. 6.

Further, in some embodiments, the electronic control unit 102a may be a master device or controller that performs the initial calculations, comparisons, determinations, and other logic functions for the redundant sensing system 10 such that the electronic control units 102b, 102c each act as a slave device. As a result, the electronic control unit 102a may control the redundant sensing system 10 to use a particular sensor, a particular buffer array, and/or pass control to another electronic control unit (e.g., the electronic control units 102b, 102c), as discussed in greater detail herein. As such, the electronic control unit 102a may be communicatively coupled to the electronic control units 102b, 102c via, for example, communication paths 114a, 114b to communicate with the other electronic control units of the redundant sensing system 10.

In some embodiments, the communication between the electronic control units 102a, 102b, 102c via the communication paths 114a, 114b may be bi-directional and may be wired or wireless. For example, the communication may be via a wide area network (WAN), such as the internet, a mobile communications network, a metropolitan area network (MAN), and/or a public service telephone network (PSTN), a local area network (LAN), a personal area network (PAN), a virtual private network (VPN), and/or other network and/or wired to one another using techniques known to those skilled in the art.

In other embodiments, the electronic control units 102a, 102b, 102c may each communicate with one another to perform the calculations, comparisons, determinations, and the like, as discussed herein, and there may not be a master device or controller, or the master device or controller, may shift between the electronic control units 102a, 102b, 102c.

The redundant sensing system 10 further includes sensors 104a, 104b, and is illustrated with a third “M” sensor 104c. It should be understood that the third “M” sensor 104c may be optional or may be any number of additional sensors (i.e., one or more third sensors 104c) in the redundant sensing system 10 and corresponds to the third “N” electronic control unit 102c, as discussed in greater detail herein. That is, generally, there is one electronic control unit for each sensor such that, for example, in a system with four sensors, there would be four electronic control units, with each electronic control unit configured to receive a data or signal from each of the sensors, as discussed in greater detail herein.

The sensors 104a, 104b, 104c may each be configured to generally sense in real time current or active positioning of various moving components, such as those discussed above with reference to FIGS. 1-3, and/or the like, so as to provide feedback during operation. More specifically, the sensors 104a, 104b, 104c may each transmit a plurality of data outputs 116a, 116b, 116c, respectively, either wired or wirelessly, indicative of a sensed position to a respective buffer array, as explained in greater detail herein. It should be understood that the for ease of understanding, the plurality of data outputs 116a, 116b, 116c are illustrated as a single output for each of the sensors 104a, 104b, 104c. This is non-limiting and the plurality of data outputs 116a, 116b, 116c may each include one or more signals output from each of the sensors 104a, 104b, 104c such as multiple data streams, high voltage signals, low voltage signals, and the like.

In some embodiments, the sensors 104a, 104b, 104c may all be a Hall Effect type sensor or all be an inductive type sensor. In other embodiments, each of the sensors 104a, 104b, 104c may be a Hall Effect type sensor or an inductive type sensor (e.g., a combination of sensor types such that one is Hall Effect and another is an inductive type). In yet other embodiments, each of the sensors 104a, 104b, 104c may be a laser-based sensor, a proximity sensor, a fluid level detection sensor, a pressure sensor, capacitive based sensor, resistive based sensor, any combination thereof, and/or any other type of sensor that one skilled in the art may appreciate.

Further, the redundant sensing system 10 may include at least two buffer arrays 106a, 106b communicatively coupled to a respective sensor (e.g., the sensors 104a, 104b, respectively). That is, the buffer array 106a is communicatively coupled to the first sensor 104a and the buffer array 106b is communicatively coupled to the second sensor 104b in an in-line or series arrangement between the sensors 104a, 104b and the electronic control units 102a, 102b, respectively. As such, each of the at least two buffer arrays 106a, 106b are positioned to receive data signals and/or electric signals from the sensors 104a, 104b and transmit data signals and/or electric signals to the electronic control units 102a, 102b. As such, the at least two buffer arrays 106a, 106b are configured to transmit identical or similar signals (within a predetermined error percentage) to each of the electronic control units 102a, 102b indicative of the position data from the sensors 104a, 104b, respectively, such that each electronic control units 102a, 102b analyzes identical or similar data.

In the illustrated embodiment, an additional “M” buffer array 106c is included to be communicatively coupled to the third “M” sensor 104c and to the third “N” electronic control unit 102c. It should be understood that more of the “M” buffer arrays 106c (e.g., additional buffer arrays or one or more third buffer arrays 106c) may be included for any additional number of “M” sensors 104c in the redundant sensing system 10 and may also be positioned between any additional “M” sensors 104c and any number of additional “N” electronic control units 102c. As such, the “M” buffer arrays 106c may be optional if only two sensors and electronic control units are present in the redundant sensing system 10 or there may be additional “M” buffer arrays 106c when there are more than two sensors and corresponding electronic control units present in the redundant sensing system 10. Further, the “M” buffer array 106c is identical to the buffer arrays 106a, 106b.

As such, it should be appreciated that in systems with multiple sensors, the same number of buffer arrays are used for the number of sensors and the same number of electronic control units are also used. For example, in the illustrated embodiments, the buffer arrays 106a, 106b, 106c correspond to the sensors 104a, 104b, 104c, respectively. As such, in the arrangement of the redundant sensing system 10, the number of sensors is reduced since each sensor is output to electronic control units 102a, 102b, 102c and all of the electronic control units 102a, 102b, 102c receive the same sensor output data.

In some embodiments, each of the buffer arrays 106a, 106b, 106c may be configured as an analog-to-digital converter to convert the plurality of data outputs 116a, 116b, 116c (e.g., analog signal indicative of the sensed position data) into identical or similar digital signals (e.g., within a predetermined error percentage), which are then transmitted by the buffer arrays 106a, 106b, 106c to the electronic control units 102a, 102b, 102c, respectively, using electrical components. Example electrical components may include, without limitation, AD converters, integrated circuits, operational amplifiers, inverters, comparator circuits, and the like. As such, each of the buffer arrays 106a, 106b, 106c receive the plurality of outputs 116a, 116b, 116c of the sensors 104a, 104b, 104c that corresponds to the buffer arrays 106a, 106b, 106c that corresponds to the sensors 104a, 104b, 104c, which then converts the received analog signals, splits the signal into three new outputs as digital output signals 118a, 118b, 118c, which is then transmitted to and received by the electronic control units 102a, 102b, 102c, respectively.

In other embodiments, each of the buffer arrays 106a, 106b, 106c may be a set of digital buffers whose inputs (e.g., the plurality of data outputs 116a, 116b, 116c) from the respective sensors 104a, 104b, 104c are converted to a digital signal. As such, the digital buffer may be an electronic circuit element that may be used to isolate the input to the buffer array (e.g., the plurality of data outputs 116a, 116b, 116c of the sensors 104a, 104b, 104c) from the digital output signals 118a, 118b, 118c (e.g., data signals, voltage signals, combination thereof, and the like) of the buffer arrays 106a, 106b, 106c, respectively.

As such, in either embodiment, the digital output signals 118a, 118b, 118c of the buffer arrays 106a, 106b, 106c, respectively, mirror the input signal of the buffer arrays 106a, 106b, 106b, respectively, but in a digital form (e.g., the plurality of data outputs 116a, 116b, 116c of the sensors 104a, 104b, 104c, respectively), and provides an inline buffer between each of the sensors 104a, 104b, 104c and each electronic control units 102a, 102b, 102c, respectively, of the redundant sensing system 10 such that a failure on the output side will not affect the input from the sensors 104a, 104b, 104c, respectively, and does not affect input into the electronic control units 102a, 102b, 102c to cause a malfunction of the electronic control units 102a, 102b, 102c.

It should be appreciated that a variety of electronic devices such as voltage buffers, comparators, and/or the like may be used as digital buffer. Further, these electronic devices may be dual voltage, dual comparators, and/or the like, that permits two outputs to mirror two inputs in one device.

As such, the digital output signals 118a, 118b, 118c, are converted, transformed, adjusted, and the like, such that each is identical or similar (within a predetermined error difference) for analysis by the electronic control units 102a, 102b, 102c, respectively, as discussed in greater detail herein. In some embodiments, the electrical components of the buffer arrays 106a, 106b, 106c, may also be configured to adjust a gain or trigger level of the signals such that the digital output signals 118a, 118b, 118c (e.g., high and low voltages) are each identical or similar (within a predetermined error difference) for analysis by the electronic control units 102a, 102b, 102c, respectively. For example, the low voltage may adjusted to be below 0.5 V and the high voltage may be adjusted to be above 4.1 V such that the gain or trigger levels match those of the electronic control units 102a, 102b, 102c. As such, this arrangement permits each of the electronic control units 102a, 102b, 102c to compare identical signals to easily identify failures, eliminate false failures, and the like.

That is, real world cable differences and electronic control unit differences are minimized or eliminated such that the digital output signals 118a, 118b, 118c may be the same, or identical, to be independently analyzed by the electronic control units 102a, 102b, 102c. As such, false failures are minimized. Further, the redundant sensing system 10 may determine an actual failure when there is discrepancies in the data. For example, in one case a discrepancy between any of the digital output signals 118a, 118b, 118c indicative of the position data output by the sensors 104a, 104b, 104c received by one of the electronic control units 102a, 102b, 102c (e.g., a discrepancy between any of the digital output signals 118a, 118b, 118c input into one of the electronic control units 102a, 102b, 102c and analyzed by the one of the electronic control units 102a, 102b, 102c) which may indicate a failure of the sensor. In another case, a discrepancy between any of the digital output signals 118a, 118b, 118c analyzed and compared between two different electronic control units 102a, 102b, 102c, which may be indicative of a failure of one of the electronic control units 102a, 102b, 102c, as discussed in greater detail herein.

In operation, the data output 116a of the sensor 104a is received by the buffer array 106a, which converts the data output 116a indicative of sensed data position, movement, and the like, of a desirable component, such as, without limitation, a component of FIGS. 1-3, from an analog to a digital signal within predetermined parameters and transmits the digital output signal 118a to each of the electronic control units 102a, 102b, 102c in the redundant sensing system 10. As such, each of the electronic control units 102a, 102b, 102c receive the same data sensed by the sensor 104a and may independently perform an analysis with the received data (e.g., the digital output signals 118a, 118b, 118c).

Further, the data output 116b of the sensor 104b is received by the buffer array 106b, which converts the data output 116b indicative of sensed position, movement, and the like, of the desirable component, such as, without limitation, the component of FIGS. 1-3, from an analog to a digital signal within predetermined parameters and transmits the digital output signal 118b to each of the electronic control units 102a, 102b, 102c in the redundant sensing system 10. As such, each of the electronic control units 102a, 102b, 102c receive the same data sensed by the sensor 104b and may independently perform an analysis with the received data. Further, the data output 116b of the sensor 104b is the same sensed position, movement, and the like, of the desired component, such as, for example, the components of FIGS. 1-3, so to allow for a secondary or redundant check of the same positioning data.

Additionally, the data output 116c of the sensor 104c is received by the buffer array 106c, which converts the data output 116c indicative of sensed position, movement, and the like of the desirable component, such as, without limitation, the component of FIGS. 1-3, from an analog to a digital signal and transmits the digital output signal 118c to each of the electronic control units 102a, 102b, 102c in the redundant sensing system 10. As such, each of the electronic control units 102a, 102b, 102c receive the same data (e.g., similar to data sensed by the sensors 104a, 104b) sensed by the sensor 104c and may independently perform an analysis with the received data. Further, the data output 116c of the sensor 104c is the same sensed position, movement, and the like of the desired component, such as, for example, the component of FIGS. 1-3, so to allow for a secondary or redundant check of the same data.

This arrangement provides several advantages over conventional systems. For example, there may be a discrepancy between the data as analyzed by the electronic control unit 102a and the same data analyzed by the electronic control units 102b, 102c. As such, this discrepancy may indicate a failure of one of the electronic control units 102a. Further, the various data received from the sensors 104a, 104b, 104c may be compared by one of the electronic control units 102a, 102b, 102c, respectively, to determine whether there is a failure in the sensor or the electronic control unit itself. For example, the electronic control unit 102a receives the position data from each of the sensors 104a, 104b, 104c such that the electronic control unit 102a may compare the data from each of the sensors 104a, 104b, 104c to determine whether or not there is a discrepancy in the received data indicative of a failure of one of the sensors 104a, 104b, 104c or the electronic control unit 102a.

For example, when it is determined that there is a discrepancy in one of the digital output signals 118a, 118b, 118c received from the buffer arrays 106a, 106b, 106c, the sensor and/or buffer array that generated the data may have an abnormal function such as a failure, a short circuit, or other undesirable operating condition. As such, the data received cannot be used or trusted and the electronic control unit 102a may switch the redundant sensing system 10 to only use data from the other sensors of the redundant sensing system 10. That is, the redundant sensing system 10 is configured to operate normally or operate within a normal range when one or more sensors fail using the other normally operating sensors.

Further, the comparison may be between the electronic control units 102a, 102b, 102c to determine whether the data provided by the sensors 104a, 104b, 104c, and/or the buffer arrays 106a, 106b, 106c may have an abnormal function such as a failure, a short circuit, or other undesirable condition, and/or the comparison may be used to determine whether there is a failure in one of the electronic control units 102a, 102b, 102c. As such, the redundant sensing system 10 is configured to operate normally not only when one or more sensors fail using the other normally operating sensors, but also in the case where one or more electronic control units fail using the other normally operating electronic control units.

It should be appreciated that this arrangement for each of the buffer arrays 106a, 106b, 106c communicatively coupled inline and between each of the sensors 104a, 104b, 104c and to transmit data to each of the electronic control units 102a, 102b, 102c, respectively, may permit for determinations of whether there is any discrepancies indicative of a component error or failure of the redundant sensing system 10.

Further, it should be appreciated that in the arrangement of the redundant sensing system 10, any failure by the electronic control units 102a, 102b, 102c, such as a short circuit, will not affect the output of the sensors 104a, 104b, 104c (e.g., the plurality of data outputs 116a, 116b, 116c). As such, the non-failed electronic control units would receive the output from the sensors 104a, 104b, 104c (e.g., the plurality of data outputs 116a, 116b, 116c through the buffer arrays 106a, 106b, 106c) to continually receive data indicative to the sensor readings as if there is not a failed device.

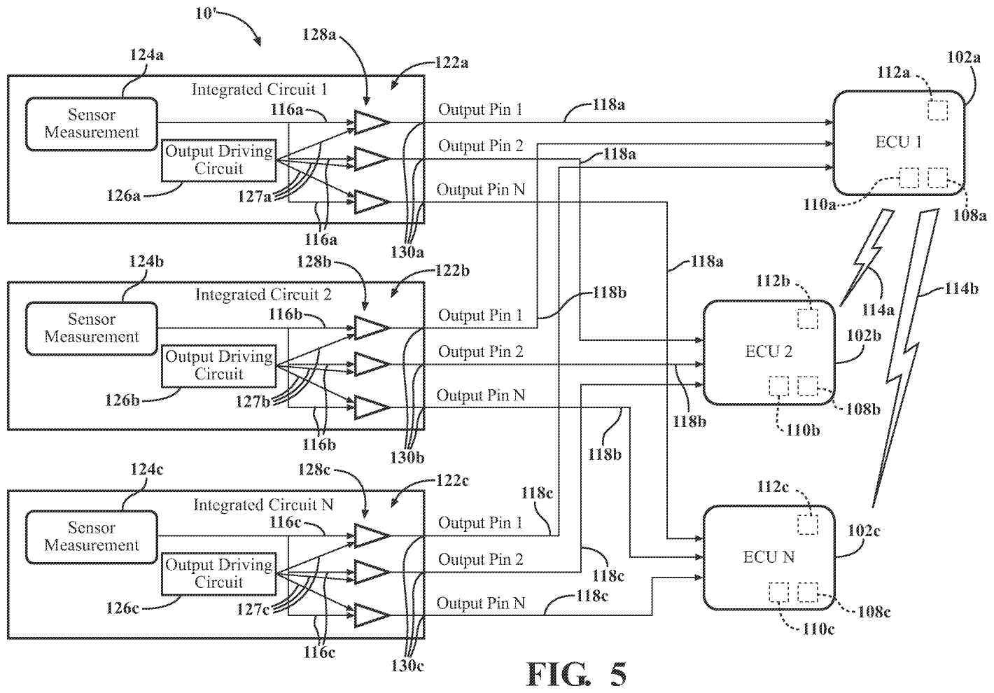

Now referring to FIG. 5, the redundant sensing system 10′ may also be implemented as a chip-level implementation to be incorporated within an integrated circuits 122a, 122b, 122c, such as an application specific integrated circuit (ASIC). Each of the integrated circuits 122a, 122b, 122c is identical to the redundant sensing system 10 of FIG. 4 except the redundant sensing system 10′ is implemented in the integrated circuits 122a, 122b, 122c. As such, those skilled in the art will understand that similar components may be described with the only difference is the chip level implementation compared to the redundant sensing system 10 of FIG. 4.

Each of the integrated circuits 122a, 122b, 122c may include a sensor measurement 124a, 124b, 124c and an output driving circuit 126a, 126b, 126c. The sensor measurements 124a, 124b, 124c may be similar to the sensors 104a, 104b, 104b in that each of the sensor measurements 124a, 124b, 124c gather, receive, or otherwise transmit position data for desirable components, such as without limitation, the components of FIGS. 1-3, and output that data as the plurality of data outputs 116a, 116b, 116c indicative of the position data.

Further, each of the output driving circuits 126a, 126b, 126b of the integrated circuits 122a, 122b, 122c drive the plurality of data outputs 116a, 116b, 116c, through the electrical components 128a, 128b, 128c, respectively, and to the corresponding output pins 130a, 130b, 130c of the integrated circuits 122a, 122b, 122c. The electrical components 128a, 128b, 128c may be operational amplifiers, diodes, inventers, and the like. As such, each of the electrical components 128a, 128b, 128c, receive the output (e.g., the plurality of data outputs 116a, 116b, 116c) of the sensor measurement 124a, 124b, 124c that corresponds to the particular output driving circuit 126a, 126b, 126c and driving signals 127a, 127b, 127c, thereof, and the electrical components 128a, 128b, 128c, which is then adjusted, transformed, and/or modified such that identical signals are transmitted through the output pins 130a, 130b, 130c to the electronic control units 102a, 102b, 102c, respectively, as the digital outputs 118a, 118b, 118c, as discussed above with respect to FIG. 4.

Referring back to FIGS. 1-5 and now to FIG. 6, in which a flow diagram that graphically depicts an illustrative process 600 of determining whether a failure of the redundant sensing system has occurred is schematically depicted. Although the steps associated with the blocks of FIG. 6 will be described as being separate tasks, in other embodiments the blocks may be combined or omitted. Further, while the actions associated with the blocks of FIG. 6 will be described as being performed in a particular order, in other embodiments, the actions may be performed in a different order.

Further, for ease of understanding, the electronic control unit 102a, the sensor 104a and the buffer array 106a are now referred to as the first electronic control unit 102a, the first sensor 104a, and the first buffer array 106a, respectively. Further, the electronic control unit 102b, the sensor 104b and the buffer array 106b are now referred to as the second electronic control unit 102b, the second sensor 104b, and the second buffer array 106b, respectively. Further, the electronic control unit 102c, the sensor 104c and the buffer array 106c are now referred to as the one or more third electronic control units 102c, the one or more third sensors 104c, and the one or more third buffer arrays 106c, respectively.

At block 605, the redundant sensing system 10 receives a signal from each of the sensors 104a, 104b, 104c. The signal is indicative of the current, in real time, position of the desired components to be monitored, such as, without limitation, those discussed with respect to FIGS. 1-3 above. For example, the current position or movement of the pedal arms, shafts, and the like. At block 610, the first electronic control unit 102a of the redundant sensing system 10 analyzes the data received. This is non-limiting and the data may be analyzed by any or all of the electronic control units 102a, 102b, 102c. In this non-limiting example, the first electronic control unit 102a is a master device or controller that initially performs all the analysis. This is non-limiting and any of the second electronic control unit 102b or the one or more third electronic control units 102c may be the master device or controller. The received data may be generated or transmitted originally by the sensors 104a, 104b, 104c, which is then converted and adjusted or otherwise modified by the buffer arrays 106a, 106b, 106c into the digital signals, which are identical and transmitted to the electronic control units 102a, 102b, 102c.

Once the data is received and analyzed by the first electronic control unit 102a, a determination is made as to whether the received position data output by the first sensor 104a through the first buffer array 106a as the digital signal is within a predetermined threshold range or value, at block 615. The predetermined threshold range or value may be a range or value of normal operations of the sensors 104a, 104b, 104c and the buffer arrays 106a, 106b, 106c. When the position data is within the predetermined threshold range or value, then the process 600 returns to block 605 and loops between blocks 605-615 until the position data received is not within the predetermined threshold range or value (e.g., abnormal operations).

When the position data transmitted from the first sensor 104a through the first buffer array 106a is not within the predetermined threshold range or value, at block 620, a determination is made whether the position data received from another sensor (e.g., the second sensor 104b, and/or the one or more third sensors 104c) is within the predetermined threshold range or value. Such a determination may be made by the first electronic control unit 102a using lookup tables, and the like, stored in the data storage device and the determination may be made using the logic modules and/or the processor. Further, the predetermined threshold range or value may be customized for each component that may be desired to be monitored. That is, the different pedal assemblies discussed above in FIGS. 1-2 may have different predetermined threshold ranges or values and the steer-by-wire assembly discussed with respect to FIG. 3 may have another or different predetermined threshold range or value.

In another embodiment, when the position data transmitted from the first sensor 104a through the first buffer array 106a is not within the predetermined threshold range or value, then at block 620, a determination is made whether the position data received from all of the remaining sensors (e.g., the second sensor 104b and the one or more third sensors 104c) is within the predetermined threshold range or value. Such a determination may be made by the first electronic control unit 102a using lookup tables, and the like, stored in the data storage device and the determination may be made using the logic modules and/or the process. The determination may also be made by the first electronic control unit 102a communicating with the second electronic control unit 102b using lookup tables, and the like, stored in the data storage device to compare data received from all three sensors 104a, 104b, 104c.

When the position data of the second sensor 104b or the third or more sensors 104c is within the predetermined threshold range or value, the first electronic control unit 102a instructs or controls the redundant sensing system 10 to continue to operate with either the second sensor 104b, or the one or more third sensors 104c, at block 625. That is, it is determined that the sensor 104a and/or buffer array 106a has malfunctioned or otherwise failed and the redundant sensing system 10 may operate normally using another one of the sensors such as the second sensor 104b, and/or the one or more third sensors 104c. Further, it should be understood that the redundant sensing system 10 monitors the data output by the newly used sensor (e.g., the second sensor 104b and the one or more third sensors 104c) by beginning the process 600 again at block 605.

When the position data of the second sensor 104b (or the third or more sensors 104c) is not within, exceeds, or is below the predetermined threshold range or value at block 630, the electronic control unit 102a compares the position data generated by one of the sensors (e.g., the first sensor 104a, the second sensor 104b, and/or the third or more sensors 104c) received by the first electronic control unit 102a with the position data generated by the same one of the sensors (e.g., sensors 104a, 104b, 104c) that was received by at least another one of the electronic control units (e.g., the second electronic control unit 102b or the third or more electronic control units 102c). That is, when the position data of the second sensor 104b (or the one or more third sensors 104c) does not meet the predetermined threshold range or value at block 630, then, in the illustrated embodiment, a comparison is made by the first electronic control unit 102a of the position data received from one of the sensors (e.g., sensors 104a, 104b, 104c) to the position data received from one of the sensors (e.g., sensors 104a, 104b, 104c) by a different electronic control unit (e.g., the second electronic control unit 102b or the one or more third more electronic control units 102c). As a result, the comparison provides the redundant sensing system 10 with information regarding whether each the first electronic control unit 102a and the second electronic control unit 102b (or the one or more third electronic control units 102c) receives the same position data or whether there is a deviation between the first electronic control unit 102a and the second electronic control unit 102b (or the one or more third electronic control units 102c) indicative of a failure of the first electronic control unit 102a.

In another embodiment, when the position data of the second sensor 104b (or the one or more third sensors 104c) does not meet the predetermined threshold range or value at block 630, then a comparison is made by the first electronic control unit 102a of the position data received from all of the sensors (e.g., sensors 104a, 104b, 104c) to the position data received from all of the sensors (e.g., sensors 104a, 104b, 104c) by a different electronic control unit (e.g., the second electronic control unit 102b or the one or more third more electronic control units 102c). As a result, the comparison provides the redundant sensing system 10 with information regarding whether each the first electronic control unit 102a and the second electronic control unit 102b (or the one or more third electronic control units 102c) receives the same position data or whether there is a deviation between the first electronic control unit 102a and the second electronic control unit 102b (or the one or more third electronic control units 102c) indicative of a failure of one of the electronic control units 102a, 102b, 102c such as the first electronic control unit 102a.

As such, at block 635, an analysis of the comparison data is preformed to determine whether there is a discrepancy between the same received data of the first electronic control unit 102a and the second electronic control unit 102b (or the one or more third electronic control units 102c). When there is not a discrepancy, the electronic control unit 102a instructs or controls the redundant sensing system 10 to continue to operate with the second sensor 104b and/or the one or more third sensors 104c, at block 625.

When the analysis of the comparison data is determined that there is a discrepancy between the same received data of the first electronic control unit 102a and the second electronic control unit 102b (or the one or more third electronic control units 102c), at block 635, then the data received by the second electronic control unit 102b (or the one or more third electronic control units 102c) is analyzed to determine whether the compared data is within an ECU predetermined threshold range or value, at block 640. The ECU predetermined threshold range or value may be a range or value of normal operations of the electronic control units 102a, 102b, 102c. When the position data received by the second electronic control unit 102b (or the one or more third electronic control units 102c) is not within or does not meet the ECU predetermined threshold range or value, then, at block 625, the first electronic control unit 102a instructs or controls the redundant sensing system 10 to continue to operate with the second sensor 104b, and the one or more third sensors 104c. That is, it is determined that the electronic control units 102a, 102b, 102c are operating normally, but a determination is made that the first sensor 104a and/or the first buffer array 106a, or components thereof, have failed.

When the received position data of the second electronic control unit 102b (or the third or more electronic control units 102c) is within or meets the ECU predetermined threshold range or value, then, at block 645, the first electronic control unit 102a gives control to the second electronic control unit 102b (or the third or more electronic control units 102c) to act as the master controller or device and to perform the operations of the process 600. That is, it is determined that the first electronic control unit 102a is operating abnormally, but the first sensor 104a and/or the first buffer array 106a, or components thereof are operating normally.

It should now be appreciated that the redundant sensing systems disclosed herein provides advantages over conventional systems by minimizing the number of sensors, minimizing the number of electronic control units, communication between the electronic control units when deviations are determined to troubleshoot the root cause of the deviation, reducing of false fails, and automatic switching and/or assignment of sensors or electronic control units to use in the redundant sensing system.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A redundant sensing system comprising:
a first sensor configured to output a first data indicative of a position data;
a second sensor configured to output a second data indicative of the position data; and
an electronic control unit communicatively coupled to the first sensor and the second sensor, the electronic control unit configured to receive the first data indicative of the position data and the second data indicative of the position data, the electronic control unit further configured to:
determine whether the first data indicative of the position data is within a first predetermined threshold range, the first predetermined threshold range being a range of normal operation of the first sensor and the electronic control unit,
when the first data is outside of the first predetermined threshold range, determine whether the second data indicative of the position data is within a second predetermined threshold range, the second predetermined threshold range being a range of normal operation of the second sensor and the electronic control unit, and
control the redundant sensing system to operate with the second sensor when the first data is outside of the first predetermined threshold range and the second data is within the second predetermined threshold range.

2. The redundant sensing system of claim 1, further comprising:
a first buffer array positioned to be communicatively coupled between the first sensor and the electronic control unit.

3. The redundant sensing system of claim 2, further comprising:
a second buffer array positioned to be communicatively coupled between the second sensor and the electronic control unit; and
a second electronic control unit communicatively coupled to the first buffer array and the second buffer array, the second electronic control unit configured to receive the first data indicative of the position data and the second data indicative of the sensed position data.

4. The redundant sensing system of claim 3, wherein the electronic control unit further configured to:
compare the first data received from the first sensor by the electronic control unit with the first data received from the first sensor by the second electronic control unit; and
determine whether a variation exists indicative of an abnormal operation of the first sensor, the second sensor, or the electronic control unit.

5. The redundant sensing system of claim 3, wherein the first buffer array receives the first data indicative of the position data and outputs the first data as two data signals, one to the electronic control unit and one to the second electronic control unit.

6. The redundant sensing system of claim 3, wherein the second buffer array receives the second data indicative of the position data and outputs the second data as two data signals, one to the electronic control unit and one to the second electronic control unit.

7. The redundant sensing system of claim 1, wherein the first sensor is one of an inductive type sensor or a Hall Effect sensor and the second sensor is one of a Hall Effect type sensor or an inductive type sensor.

8. A redundant sensing system comprising:
a first sensor configured to output a first data indicative of a position data;
a second sensor configured to output a second data indicative of the position data;
a third sensor configured to output a third data indicative of the position data;
a first electronic control unit communicatively coupled to the first sensor, the second sensor and the third sensor and configured to receive the first data indicative of the position data, the second data indicative of the position data, and the third data indicative of the position data;
a second electronic control unit communicatively coupled to the first sensor, the second sensor and the third sensor and configured to receive the first data indicative of the position data, the second data indicative of the position data, and the third data indicative of the position data; and
a third electronic control unit communicatively coupled to the first sensor, the second sensor and the third sensor and configured to receive the first data indicative of the position data, the second data indicative of the position data, and the third data indicative of the position data,
the first electronic control unit further configured to:
determine whether the first data indicative of the position data is within a first predetermined threshold range, the first predetermined threshold range being a range of normal operation of the first sensor and the first electronic control unit,
when the first data is outside of the first predetermined threshold range, determine whether the second data indicative of the position data is within a second predetermined threshold range, the second predetermined threshold range being a range of normal operation of the second sensor and the first electronic control unit, and
control the redundant sensing system to operate with the second sensor when the first data is outside of the first predetermined threshold range and the second data is within the second predetermined threshold range.

9. The redundant sensing system of claim 8, wherein the first sensor is one of an inductive type sensor or a Hall Effect sensor, the second sensor is one of a Hall Effect type sensor or an inductive type sensor, and the third sensor is one of a Hall Effect type sensor or an inductive type sensor.

10. The redundant sensing system of claim 8, further comprising:
a first buffer array positioned to be communicatively coupled between the first sensor and the electronic control unit;
a second buffer array positioned to be communicatively coupled between the second sensor and the second electronic control unit; and
a third buffer array positioned to be communicatively coupled between the third sensor and the third electronic control unit.

11. The redundant sensing system of claim 10, wherein the first buffer array receives the first data indicative of the position data and outputs the first data as three data signals, one to the first electronic control unit, one to the second electronic control unit, and one to the third electronic control unit.

12. The redundant sensing system of claim 10, wherein the second buffer array receives the second data indicative of the position data and outputs the second data as three data signals, one to the first electronic control unit, one to the second electronic control unit, and one to the third electronic control unit.

13. The redundant sensing system of claim 10, wherein the first electronic control unit is further configured to:
compare the first data received from the first sensor by the first electronic control unit with the first data received from the first sensor by the second electronic control unit; and
determine whether a variation exists indicative of an abnormal operation of the first sensor, the second sensor, or the first electronic control unit.

14. The redundant sensing system of claim 10, wherein the first electronic control unit is further configured to:
compare the first data received from the first sensor by the second electronic control unit with the first data received from the first sensor by the third electronic control unit; and
determine whether a variation exists indicative of an abnormal operation of the first sensor, the second sensor, or the second electronic control unit.

15. The redundant sensing system of claim 10, wherein the first electronic control unit further configured to:
compare the first data received from the first sensor by the first electronic control unit with the first data received from the first sensor by the third electronic control unit; and
determine whether a variation exists indicative of an abnormal operation of the first sensor, the third sensor, or the first electronic control unit.

16. A redundant sensing system comprising:
a first integrated circuit having a first measurement sensor configured to output a first data indicative of a position data;
a second integrated circuit having a second measurement sensor configured to output a second data indicative of the sensed position;
an electronic control unit communicatively coupled to the first integrated circuit and the second integrated circuit, the electronic control unit configured to receive the first data indicative of the sensed position and the second data indicative of the sensed position, the electronic control unit further configured to:
determine whether the first data indicative of the sensed position is within a first predetermined threshold range, the first predetermined threshold range being a range of normal operation of the first integrated circuit and the electronic control unit,
when the first data is outside of the first predetermined threshold range, determine whether the second data indicative of the sensed position is within a second predetermined threshold range, the second predetermined threshold range being a range of normal operation of the second integrated circuit and the electronic control unit, and
control the redundant sensing system to operate with the second integrated circuit when the first data is outside of the first predetermined threshold range and the second data is within the second predetermined threshold range.

17. The redundant sensing system of claim 16, wherein the first measurement sensor includes data collected from one of an inductive type sensor or a Hall Effect sensor and the second the second measurement sensor includes data collected from one of a Hall Effect type sensor or an inductive type sensor.

18. The redundant sensing system of claim 16, further comprising:
a second electronic control unit communicatively coupled to the first integrated circuit and the second integrated circuit, the second electronic control unit configured to receive the first data indicative of the sensed position and the second data indicative of the sensed position.

19. The redundant sensing system of claim 18, further comprising:
a first drive circuit and electrical components configured to receive the first data indicative of the position data and output the first data as two data signals, one to the electronic control unit and one to the second electronic control unit; and
a second drive circuit and electrical components configured to receive the second data indicative of the position data and output the second data as two data signals, one to the electronic control unit and one to the second electronic control unit.

20. The redundant sensing system of claim 18, wherein the electronic control unit further configured to:
compare the first data received from the first measurement sensor by the electronic control unit with the first data received from the first measurement sensor by the second electronic control unit; and
determine whether a variation exists indicative of an abnormal operation of the first measurement sensor, the second measurement sensor, or the electronic control unit.
